(19) United States
(12) Patent Application Publication
(10) Pub. No.: US 2011/0261154 A1
(43) Pub. Date: Oct. 27, 2011

(54) LIGHT SHIFT COMPENSATION DEVICE OF IMAGE COMPOSITION DEVICE FOR MULTICOLOR HOLOGRAPHY

(76) Inventor: Jui-Tsung CHANG, Yangmei City (TW)

(21) Appl. No.: 12/940,107

(22) Filed: Nov. 5, 2010

(30) Foreign Application Priority Data
Apr. 23, 2010 (CN) 201020171508.5

(51) Int. Cl. H04N 5/89

(52) U.S. Cl. 348/40; 348/E05.001

(57) ABSTRACT

A light shift compensation device of an image composition device for the multicolor holography utilizes a light source provider to emit a beam split into an object beam and a reference beam via a beamsplitting unit. The object beam, shined on a projecting unit, is transformed into an object wave for projecting two-D images of the object on a negative. The reference beam is transformed into a reference wave by a compensating unit to adjust the irradiation angle and thence project on the negative. Interference fringes formed by the object wave and the reference wave projecting on the negative record two-D images of the object on the negative. The two-D images projected by the object wave are separated into the red image, the green image, and the blue image, which are directed to the three fundamental colors. The image of one single color is adopted for being recorded on the negative each time. The images of the three fundamental colors are successively processed by three times of double-exposure on the negative to compose a true color image. The angle of projection of the reference wave is adjusted by the compensating unit, so that the angles of diffraction of the green image and the blue image recorded on the negative are changed.

### BACKGROUND OF THE INVENTION

1. Field of the Invention

The present invention relates to a light shift compensation device, especially to a light shift compensation device of an image composition device for the multicolor holography that utilizes interference fringes generated by a reference wave and an object wave to record images on a negative. Thereby, the negative reconstructs a recording device for a solid image, and the reference wave adjusts an angle of irradiation via a compensating unit to previously amend angles of deviation of the diffracted three fundamental colors.

2. Description of the Related Art

The conventional device for constructing a hologram substantially separates a light source into a reference beam and an object beam. Wherein, filtered into an object wave, the object beam projects a two-D image of an object on the hologram. The reference beam filtered into a reference wave, the reference wave is projected on the hologram with an angle of incidence different from that of the object wave. Interference fringes generated by the reference wave and the object wave allow the two-D image to be recorded on the negative. Wherein, a light source provider adopts a laser generator that emits beams of various colors, such as red, green, or blue.

Beams in different colors include divergent wavelengths and angles of diffraction. Especially, while reconstructing the red image, the green image, and the blue image under the basic of a white light source, the images are unable to be superimposed since the angles of diffraction and the angles of projection of the images are all diverse. As a result, it is difficult to construct a multicolored three-D image.

FIG. 1 shows a schematic view of the conventional hologram that is unable to reconstruct a multicolored three-D image. Reconstructing the three-D image utilizes a single source 91 to serve as a back light that projects a displaying film 92 to present a solid image. If an angle of projection of the red beam 93 serves as a standard angle, a green beam 94 accordingly has a slight deviation of an angle of projection, and a blue beam 94 has an angle of projection that deviates a lot. As a result, the reconstructed solid image of such hologram contributes to monochromatic images with three separated colors, and the original color of objects cannot be faithfully presented.

The present invention intends to amend disadvantages existing in the conventional hologram that only monochromatic images could be presented. Therefore, a visual effect that presents a more faithful solid image is to be provided.

### SUMMARY OF THE INVENTION

The object of the present invention is to vary an angle of irradiation of a reference beam in accordance with images of each color and previously vary an angle of diffraction of the images of each color on a negative. Thereby, the images of divergent colors have the same angle of diffraction in time of reconstructing a solid image via a single light source, so that a complete multicolor solid image is achieved by superimposing the images of each color.

The present invention of a light shift compensation device of an image composition device for the multicolor holography comprises an illuminant unit, a beamsplitting unit, a compensating unit, a projecting unit, a capturing unit, and a negative; wherein,

the illuminant unit adopts a light source provider that emits beams;

the beamsplitting unit splits an incident beam into a reference beam and an object beam; the reference beam and the object beam are emitted by divergent angles; the reference beam travels into the compensating unit, and the object beam travels into the projecting unit;

the compensating unit includes a first filter and a fine tuning unit; the reference beam is transformed into a reference wave via the first filter so as to be shot at the negative; the fine tuning unit adjusts a position or an angle of the first filter so as to vary an angle of incidence of the reference wave shined on the negative;

the projecting unit includes a second filter, a guiding lens, a displaying plate, and an imaging lens; the displaying plate connects to the capturing unit so as to display a two-D image; the object beam is transformed into an object wave via the second filter so as to penetrate the guiding lens, the displaying plate, and the imaging lens; thereby, the two-D image on the displaying plate is projected on the negative;

the capturing unit includes a spinning stand, a recording unit, and a computer; the spinning stand is provided with a stepping motor that is rotatable; the recording unit records images and transmits the two-D image to the computer for processing; thereby, the image is displayed on the displaying plate;

the negative, recording an optical image, is disposed on the spindle stand that defines the stepping motor therein; the spindle stand rotates the negative;

the reference wave and the object wave converge on a spot of the negative; the image is recorded on the negative via interference fringes of the reference wave and the object wave; the recorded image is transformed into a hologram after fixing;

the computer processes a color separation on the two-D image and integrates the two-D image into a red image, a green image, and a blue image; thereby, the integrated images is transmitted to the displaying plate; adjusting the fine tuning unit of the compensating unit in accordance with the images in different colors controls the position or the angle of the first filter. Further, varying the angle of incidence of the reference wave shined on the negative hence changes angles of diffraction of afore images in different colors on the negative.

Practically, the illuminant unit adopts a laser generator that emits laser beams of different wavelengths. The laser beams could be classified into visible and invisible beams according to the distinct wavelengths, including a red beam, a green beam, or a blue beam.

Practically, a number of plane mirrors are installed for reflecting beams with high efficiency. Further, varying or guiding traveling routes of the beams.

Practically, the fine tuning unit adopts a motor driver or an electromagnetic driver.

Practically, the compensating unit and the projecting unit respectively install a first blocking plate and a second blocking plate that limit a scope where the reference wave and the object wave project onto the negative.

Another light shift compensation device of an image composition device for the multicolor holography comprises a compensating unit installed within the image composition device; the compensating unit is substantially composed of a filter and a fine tuning unit. The fine tuning unit serves to vary an angle of emission of a reference wave by adjusting a position or an angle of the filter.

Practically, the fine tuning unit adopts a motor driver or an electromagnetic driver.

Practically, the image composition device comprises an illuminant unit, a beamsplitting unit, a compensating unit, a projecting unit, and a negative; the illuminant unit emits a beam to the beamsplitting unit; the beam is split into a reference beam and an object beam; the reference beam travels into the compensating unit, and the object beam travels into the projecting unit; the reference beam is transformed into a reference wave via the compensating unit and projected onto the negative with a certain angle; the object beam is transformed into an object wave via the projecting unit, thereby projecting an image of the displaying plate in the projecting unit on the negative; the image is recorded on the negative via interferences of the reference wave and the object wave.

Practically, the fine tuning unit adjusts the position or the angle of the first filter in the compensating unit in accordance with images in different colors.

Different from the conventional device, the present invention substantially comprises an illuminant unit, a beamsplitting unit, a compensating unit, a projecting unit, a capturing unit, and a negative. Wherein, the illuminant unit adopts a laser generator to emit laser beams that is projected to the beamsplitting unit is thence split into a reference beam aiming at the compensating unit and an object beam aiming at the projecting unit.

The compensating unit includes the first filter and the fine tuning unit. By penetrating the first filter, the reference beam is transformed into a reference wave that is thence projected on the negative. The fine tuning unit is adopted to change the angle incidence of the reference wave.

The projecting unit includes the second filter, the displaying plate, the recording unit, and the computer. The object beam projected onto the second filter is transformed in the object wave. The recording unit captures two-D images of the object. Thereby, the captured images are processed and separated by the computer into red images, green images, and blue images. Succeedingly, the processed images are transmitted to the displaying unit in batches for being displayed. The object beam transmits to the displaying plate and projects the two-D images of the object on the negative.

The object wave and the reference wave converge on the negative. Since the angles of incidence of the two waves are divergent, interference fringes are generated to record the two-D images on the negative. Moreover, the negative is designed by an annular shape. The two-D images of the object with different angles under the same height and the same distance are sequentially and annularly recorded on the negative. Thence, the red images, the green images, and the blue images are respectively recorded on the negative for being further superimposed thereon by means of the double exposure. Thereby, a true color negative is composed.

The fine tuning unit of the compensating unit adjusts the angle of irradiation of the reference beam via a frontward-and-backward shifting or a rotating movement. That is, while recording the images in different colors that project on the negative, the compensating unit preferably varies the angle of incidence of the reference wave so as to previously change the angle of diffraction of the images. As a result, the angels of projection of the images in different colors are superimposed coherently while reconstructing a solid image by means of the white light source, and a multicolored solid image is achieved.

### BRIEF DESCRIPTION OF THE DRAWINGS

FIG. 1 is a schematic view of a conventional reconstructed solid image via the hologram; the angles of projection of images with different colors deviate;

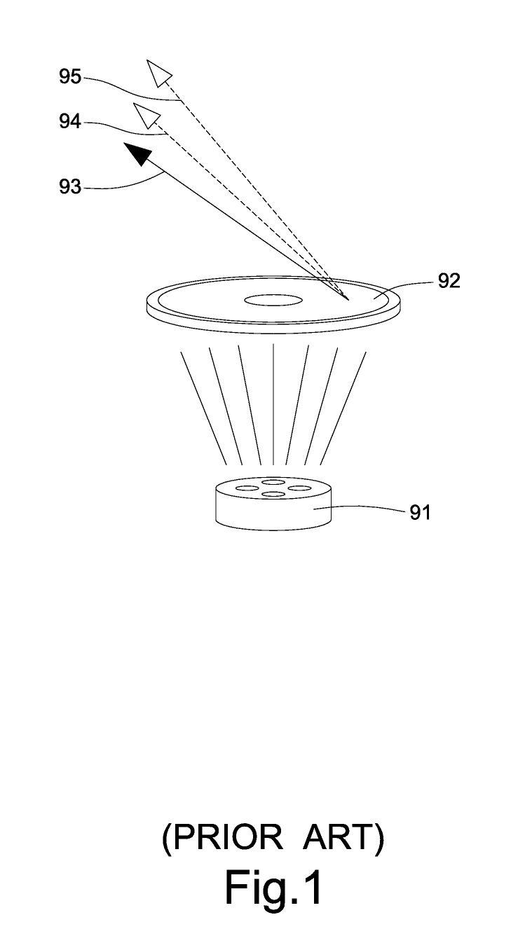

FIG. 2 is a schematic view of the present invention;

FIG. 3 is schematic view of the present invention showing the angle of irradiation of the reference wave being changed by means of varying the position or the angle of the fine tuning member in time of recording the images with lights of different colors; and

FIG. 4 is a schematic view of the present invention showing a multicolor solid image being reconstructed while the negative is disposed in front of the light source.

### DETAILED DESCRIPTION OF THE PREFERRED EMBODIMENTS

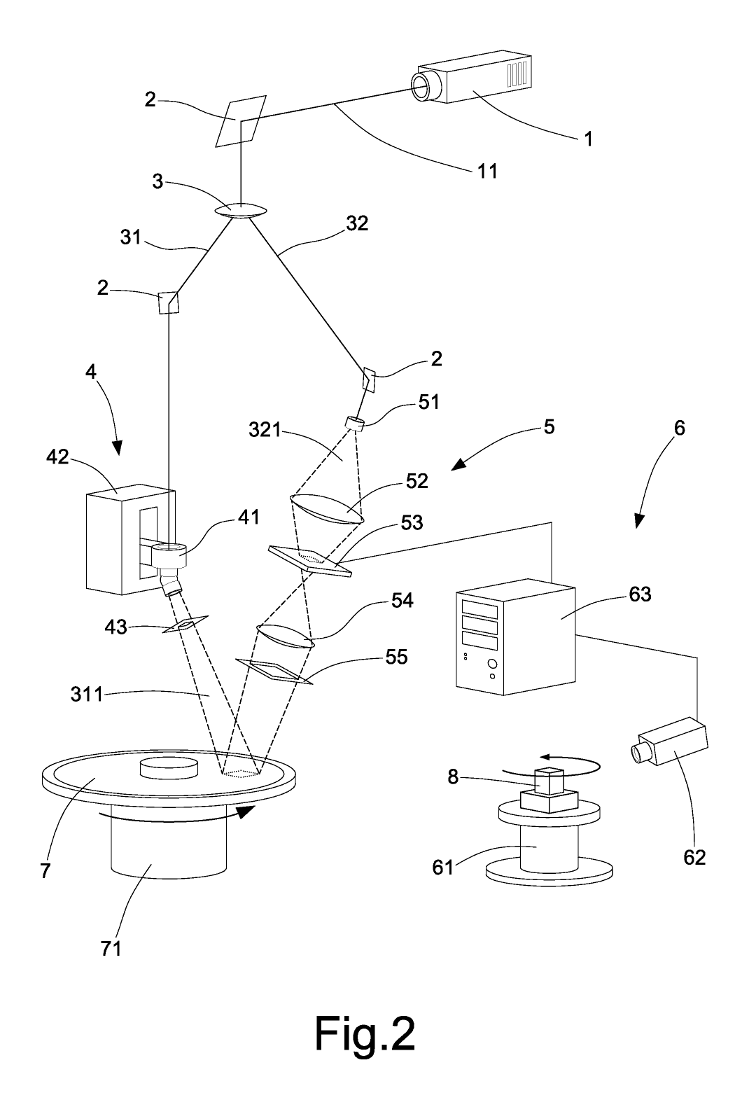

Referring to FIG. 2, a light shift compensation device of an image composition device for the multicolor holography comprises an illuminant unit 1, a number of plane mirrors 2, a beamsplitting unit 3, a compensating unit 4, a projecting unit 5, a capturing unit 6, and a negative 7.

The illuminant unit 1 adopts a laser generator that emits laser beams 11 of different wavelengths. According to the scope of the wavelength, the laser beams 11 include the invisible light and the visible light, such as the red beam, the green beam, or the blue beam.

The plane mirrors 2 without limiting the numbers, adopting the lens that reflects beams with high efficiency, are fittingly installed on the present invention for varying or guiding a traveling route of the laser beam 11.

The beamsplitting unit 3 splits the laser beam 11 into two coherent beams. Namely, by penetrating the beamsplitting unit 3, the beam 11 is split into a reference beam 31 and an object beam 32. Wherein, the reference beam 31 travels into the compensating unit 4 via one plane mirror 2, and the object beam 32 travels into the projecting unit 5 via another plane mirror 2.

The compensating unit 4 includes a first filter 41, a fine tuning unit 42, and a first blocking plate 43. The reference beam 31 is transformed into a reference wave 311 via the first filter 41 so that the reference wave 311 is projected on the negative 7 after penetrating the first blocking plate 43. The first blocking plate 43 limits a scope where the reference wave 311 project onto the negative 7. The fine tuning unit 42 adopts a motor driver or an electromagnetic driver for adjusting a front-and-rear position or a rotative angle of the first filter 41 so as to vary an angle of incidence of the reference wave 311 shined on the negative 7.

The projecting unit 5 includes a second filter 51, a guiding lens 52, a displaying plate 53, an imaging lens 54, and a second blocking plate 55. Wherein, the displaying plate 53 connects to the capturing unit 6 so as to display a two-D image. The object beam 32 is transformed into an object wave 321 by penetrating the second filter 51, which further goes through the guiding lens 52, the displaying plate 53, the imaging lens 54, and the second blocking plate 55. Thereby, the two-D image on the displaying plate 53 is projected on the negative 7. The second blocking plate 55 limits a scope of the projected two-D image shined on the negative 7.

The capturing unit 6 includes a spinning stand 61, a recording unit 62, and a computer 63. The spinning stand 61 is provided with a stepping motor that is rotatable. The recording unit 62 records images and transmits the captured images to the computer 63 for color separation, namely classifying the colors in the image. Thereby, the computer 63 further integrates the images of separated colors into a red image, a green image, and a blue image. Thereby, the integrated two-D images are transmitted to the displaying plate 53 for displaying.

The negative 7, designed by an annular shape to record an optical image, is disposed on a spindle stand 71 that defines the stepping motor therein. The spindle stand 71 rotates the negative 7. The reference wave 311 and the object wave 321 converge on a spot of the negative 7. The two-D images are recorded on the negative 7 via interference fringes of the reference wave and the object wave. The recorded image is transformed into a hologram after fixing. Accompanying with a common light source, a three-D image is reconstructed.

Further referring to FIG. 2, a multicolor hologram is produced. An object 8 is put on the spinning stand 61 and rotated. The recording unit 62 captures the images of the object and transmits the same to the computer 63 for the color separation and integration. Wherein, the two-D images are separated and integrated into the red images, the green images, and the blue images. Thence, the integrated two-D images are further transmitted to the displaying plate 53.

A laser beam with a fixed wavelength is emitted by the illuminant unit 1. The laser beam travels through the plane mirror 2 for being reflected to the beamsplitting unit 3 and thence split into a reference beam 31 and an object beam 32. The reference beam 31 is reflected to the compensating unit 4 through the plane mirror 2 and transformed into a reference wave 311 compensating unit. Thence, the reference wave is further projected on the negative 7. The object beam 32 is reflected to the projecting unit 5 through the plane mirror 2 and transformed into an object wave 321. Thence, the object wave projects the two-D images on the displaying plate 53 onto the negative 7. Finally, the reference wave 311 and the object wave 321 converge on a spot of the negative 7. The images are thence recorded on the negative 7 via interference fringes of the reference wave and the object wave.

By means of the spinning stand 61 rotating the object 8, the recording unit 62 continuously records images of the object in different angles under the same distance and at the same height level. Further, the captured two-D images in different angles are concurrently displayed on the displaying plate 53. The negative 7 successively records the two-D images in different angles of the object by means of the rotation brought about by the stepping motor. Wherein, the spinning stand 61 and the negative 7 have a synchronous rotation. Namely, one round of the spinning stand 61 contributes to one round of the negative 7.

Besides, the images on the negative 7 are recorded by means of a three-time double exposure. In the first recording, the computer 63 transmits the red two-D images to the displaying plate 53, and the negative 7 records the red images. Accordingly, after all of the red two-D images in different angles are recorded on the negative, the green-images are further recorded on the negative 7 via double-exposure. Wherein, the compensating unit 4 adjusts the angle of incidence of the reference wave 311 projected on the negative 7 so as to vary the angles of diffraction of the green images on the negative 7. Similarly, after the angle of incidence of the reference wave 311 is adjusted, the blue images are recorded on the negative 7. Herein, the double-exposed red images, green images, and blue images that are taken at the same angle have to be fully superimposed. Finally, developing and fixing the negative 7 preferably achieve a multicolor hologram.

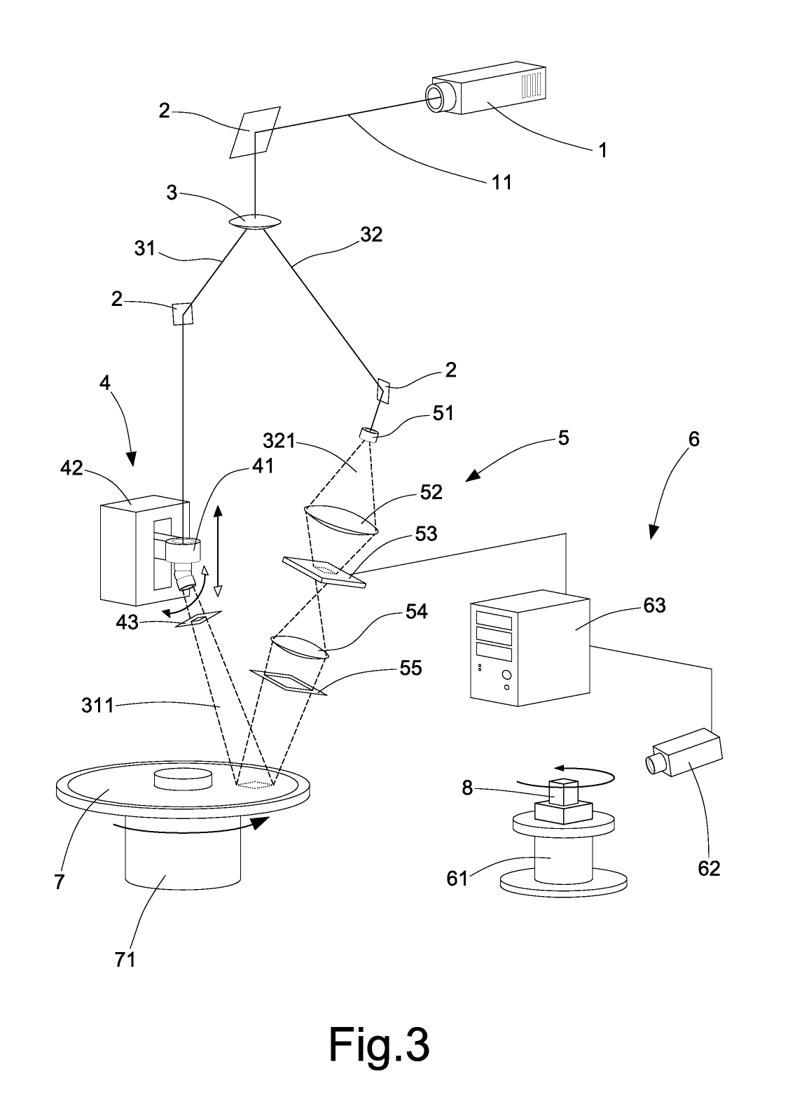

Referring to FIG. 3, while recording the green and the blue images, the fine tuning unit 41 of the compensating unit 4 varies its position or its rotative angle to change the angle of incidence of the reference wave 311 shined on the negative 7. Thereby, the angles of diffraction of the green images and of the blue images could be previously deviated on the negative 7.

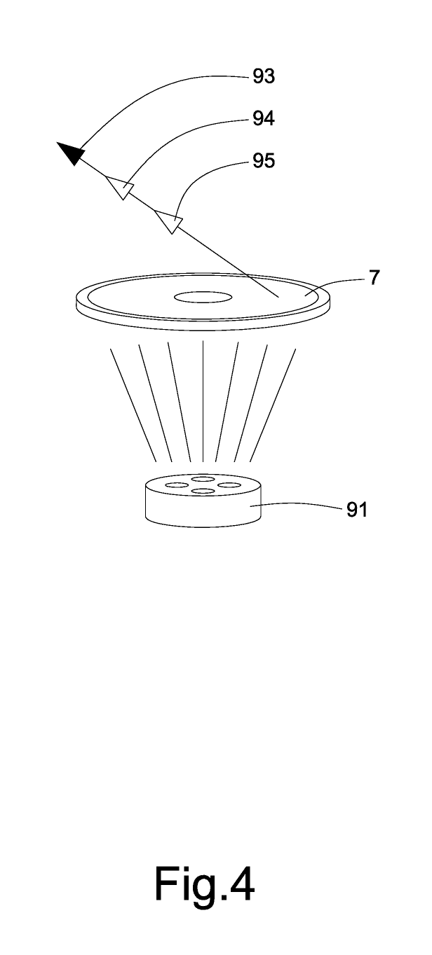

Referring to FIG. 4 when a light source 91 is utilized to reconstruct solid images, the lights of the red images, the green images, and the blue images are fully superimposed to present a faithful multicolor solid image. Wherein, the light source for reconstructing the image alternatively adopts an incandescent lamp, a light tube, or a white LED. As it should be, a compound light source composed of either the red LED, the green LED, or the blue LED is also available. In addition, the computer 63 of the present invention separates the images into the individual red pixel, the green pixel, and the blue pixel. Herein, afore three colors are directed to the three fundamental colors of light. Namely, the three fundamental colors could be further compounded into various colors. For example, a purple image is achieved by superimposing the red image on the blue image. A yellow image is achieved by superimposing the red image on the yellow image. The rest may be deduced by analogy.

I claim:

1. A light shift compensation device of an image composition device for the multicolor holography comprising an illuminant unit, a beamsplitting unit, a compensating unit, a projecting unit, a capturing unit, and a negative; wherein,
said illuminant unit adopting a light source provider that emits beams;
said beamsplitting unit splitting an incident beam into a reference beam and an object beam; said reference beam and said object beam being emitted by divergent angles; said reference beam traveling into said compensating unit, and said object beam traveling into said projecting unit;
said compensating unit including a first filter and a fine tuning unit; said reference beam being transformed into a reference wave via said first filter so as to be shined on said negative; said fine tuning unit adjusting a position or an angle of said first filter so as to vary an angle of incidence of said reference wave shined on said negative;
said projecting unit including a second filter, a guiding lens, a displaying plate, and an imaging lens; said displaying plate connecting to said capturing unit so as to display a two-D image; said object beam being transformed into an object wave via said second filter so as to penetrate said guiding lens, said displaying plate, and said imaging lens; thereby, said two-D image on said displaying plate being projected on said negative;
said capturing unit including a spinning stand, a recording unit, and a computer; said spinning stand being provided with a stepping motor that is rotatable; said recording unit recording images and transmitting said two-D image to said computer for processing; thereby, said image being displayed on said displaying plate;
said negative, recording an optical image, being disposed on said spindle stand that defines said stepping motor therein; said spindle stand rotating said negative;
said reference wave and said object wave converging on a spot of said negative; said image being recorded on said negative via interference fringes of said reference wave and said object wave; said recorded image being transformed into a hologram after fixing;
said computer processing a color separation on said two-D image and integrating said two-D image into a red image, a green image, and a blue image; thereby, said integrated images being transmitted to said displaying plate; adjusting said fine tuning unit of said compensating unit in accordance with said images in different colors controlling said position or said angle of said first filter. Further, varying said angle of incidence of said reference wave shined on said negative; hence changing angles of diffraction of afore images in different colors on said negative.

2. The device as claimed in claim 1, wherein, said illuminant unit adopts a laser generator that emits laser beams of different wavelengths; said laser beams could be classified into visible and invisible beams according to said distinct wavelengths, including a red beam, a green beam, or a blue beam.

3. The device as claimed in claim 1, wherein, a number of plane mirrors are installed for reflecting beams with high efficiency, thereby varying or guiding traveling route of said beams.

4. The device as claimed in claim 1, wherein, said fine tuning unit adopts a motor driver or an electromagnetic driver.

5. The device as claimed in claim 1, wherein, said compensating unit and said projecting unit respectively install a first blocking plate and a second blocking plate that limit a scope where said reference wave and said object wave project onto said negative.

6. A light shift compensation device of an image composition device for the multicolor holography a compensating unit being installed within said image composition device; said compensating unit being substantially composed of a filter and a fine tuning unit; said fine tuning unit serving to vary an angle of emission of a reference wave by adjusting a position or an angle of said filter.

7. The device as claimed in claim 6, wherein, said fine tuning unit adopts a motor driver or an electromagnetic driver.

8. The device as claimed in claim 6, wherein, said image composition device comprises an illuminant unit, a beamsplitting unit, a compensating unit, a projecting unit, and a negative; said illuminant unit emits a beam to said beamsplitting unit; said beam is split into a reference beam and an object beam; said reference beam travels into said compensating unit, and said object beam travels into said projecting unit; said reference beam is transformed into a reference wave via said compensating unit and projected onto said negative with a certain angle; said object beam is transformed into an object wave via said projecting unit, thereby projecting an image of said displaying plate in said projecting unit on said negative; said image is recorded on said negative via interferences of said reference wave and said object wave.

9. The device as claimed in claim 6, wherein, said fine tuning unit adjusts said position or said angle of said first filter in said compensating unit in accordance with images in different colors.
